(19) United States
(12) Patent Application Publication
(10) Pub. No.: US 2012/0081906 A1
(43) Pub. Date: Apr. 5, 2012

(54) RETROFIT KIT FOR A LIGHTING FIXTURE

(75) Inventors: Neal R. Verfuerth, Manitowoc, WI (US); Kenneth J. Wetenkamp, Plymouth, WI (US)

(73) Assignee: Orion Energy Systems, Inc.

(21) Appl. No.: 13/249,001

(22) Filed: Sep. 29, 2011

Related U.S. Application Data
(60) Provisional application No. 61/388,966, filed on Oct. 1, 2010.

(51) Int. Cl. F21V 29/00

(52) U.S. Cl. 362/294

(57) ABSTRACT

A retrofit kit for converting an existing light fixture having a housing and an energy-intensive light source, into an upgraded fixture having a more energy-efficient light source, includes an induction light bulb mountable on a coupler. A high-frequency generator is electrically connectable to the coupler and configured to be mounted on the housing in a heat-transfer relationship. A heat sink has a first side mounted to the housing in a heat-transfer relationship and a second side configured to support the coupler and the induction light bulb. The heat sink receives heat from the coupler and the induction light bulb and transfers the heat to the housing. A reflector is coupled to the housing, and has a narrow end positioned proximate the heat sink, and a wide end positioned proximate an outer edge of the housing.

### CROSS-REFERENCE TO RELATED APPLICATIONS

This patent application claims the benefit of priority under 35 U.S.C. §119(e) of U.S. Provisional Application No. 61/388,966, having a filing date of Oct. 1, 2010, titled “Retrofit Kit for a Lighting Fixture,” the complete disclosure of which is hereby incorporated by reference in its entirety.

### FIELD

The present invention relates generally to lighting fixtures. The present application relates more particularly to a retrofit kit for converting energy-intensive light fixtures into more energy-efficient lighting fixtures. The present invention relates more particularly still to a retrofit kit that is provided for converting existing dock-lighting type fixtures and similar fixtures (e.g. lighting fixture for bridges, tunnels, signage, etc.) having an energy-intensive light source, into an upgraded fixture having a more energy-efficient light source, and includes a reflector, induction lighting source, and a heat sink and coupler.

### BACKGROUND

This section is intended to provide a background or context to the invention recited in the claims. The description herein may include concepts that could be pursued, but are not necessarily ones that have been previously conceived or pursued. Therefore, unless otherwise indicated herein, what is described in this section is not prior art to the description and claims in this application and is not admitted to be prior art by inclusion in this section.

The present invention relates generally to the field of outdoor lights such as dock lights or other similar types of lights. Such dock lighting fixtures typically use energy-intensive lighting sources, such as high-intensity-discharge (HID) lamps or the like, which are costly to operate and maintain. It would be desirable to provide a cost-effective solution for retrofitting such lighting fixtures with a more energy-efficient lighting source, and in a manner that preserved certain features or structure of the existing lighting fixtures as a way to further minimize the up-front investment cost for converting the lighting fixtures to a new energy-efficient design.

### SUMMARY

According to one aspect, a retrofit kit for converting an existing light fixture having a housing and an energy-intensive light source, into an upgraded fixture having a more energy-efficient light source, includes a reflector configured to be coupled to the housing, and an induction light bulb, and a high-frequency generator configured to be coupled to the housing in a heat-transfer relationship, and a coupler coupled to the induction light bulb and electrically coupled to the high-frequency generator, and a heat sink configured to support the coupler and the induction light bulb, and to receive heat from the coupler and the induction light bulb, the heat sink configured to be coupled to the housing in a heat-transfer relationship to transfer the heat to the housing of the existing light fixture.

According to another aspect, a retrofit kit for converting an existing light fixture having a housing and an energy-intensive light source, into an upgraded fixture having a more energy-efficient light source, includes an induction light bulb mountable on a coupler, and a high-frequency generator electrically connectable to the coupler and configured to be mounted on the housing in a heat-transfer relationship, and a heat sink configured to support the coupler and the induction light bulb, and to receive heat from the coupler and the induction light bulb, the heat sink configured to be mounted to the housing in a heat-transfer relationship to transfer the heat to the housing of the existing light fixture, and a reflector configured to be coupled to the housing, the reflector having a narrow end configured for positioning proximate the heat sink, and a wide end configured for positioning proximate an outer edge of the housing.

According to yet another aspect, a method of converting an existing light fixture having a housing and an energy-intensive light source, into an upgraded fixture having a more energy-efficient light source, includes the steps of obtaining an induction light bulb, a coupler, and a high-frequency generator, and electrically connecting the high-frequency generator to the coupler, and coupling the high-frequency generator to the housing in a heat-transfer relationship, and coupling a heat sink to the housing in a heat-transfer relationship, and supporting the induction light bulb and the coupler on the heat sink, the heat sink configured to receive heat from the coupler and the induction light bulb and transfer the heat to the housing, and coupling a reflector to the housing, the reflector having a narrow end configured for positioning proximate the heat sink, and a wide end configured for positioning proximate an outer edge of the housing.

### BRIEF DESCRIPTION OF THE DRAWINGS

The disclosure will become more fully understood from the following detailed description, taken in conjunction with the accompanying figures, wherein like reference numerals refer to like elements, in which:

FIG. 1 is a schematic image of an exploded perspective view of a retrofit kit for a lighting fixture according to an exemplary embodiment.

FIG. 2 is schematic images of a heat sink portion of the retrofit kit for a lighting fixture according to the embodiment of FIG. 1.

FIG. 3 is schematic images of a reflector portion of the retrofit kit for a lighting fixture according to the embodiment of FIG. 1.

### DETAILED DESCRIPTION

Referring generally to the FIGURES, lighting fixtures and related retrofit kits, systems and methods are shown. The retrofit kit for a lighting fixture is configured for applications such as a dock lighting application, or similar type of generally outdoor lighting application (e.g. bridges, tunnels, signage, etc.). The retrofit kit is shown generally to include a reflector, an induction lighting source, a high-frequency generator, a heat sink, a coupler, and suitable hardware for adapting these components of the retrofit kit for use with portions of the existing fixture to be upgraded. Although the energy-efficient induction lighting source is shown and described herein as an 85 watt system, other systems, such as (by way of non-limiting example) 55 watts or 165 watts may be used. Further, although the reflector is shown according to one embodiment as a pyramid type reflector having certain sizes and proportions intended to fit within a rectangular housing, any suitable shape reflector having any of a variety of sizes and proportions for a particular application may be used and adapted for the size and shape of a particular housing of a fixture to be upgraded. Accordingly, all such variations are intended to be within the scope of this disclosure.

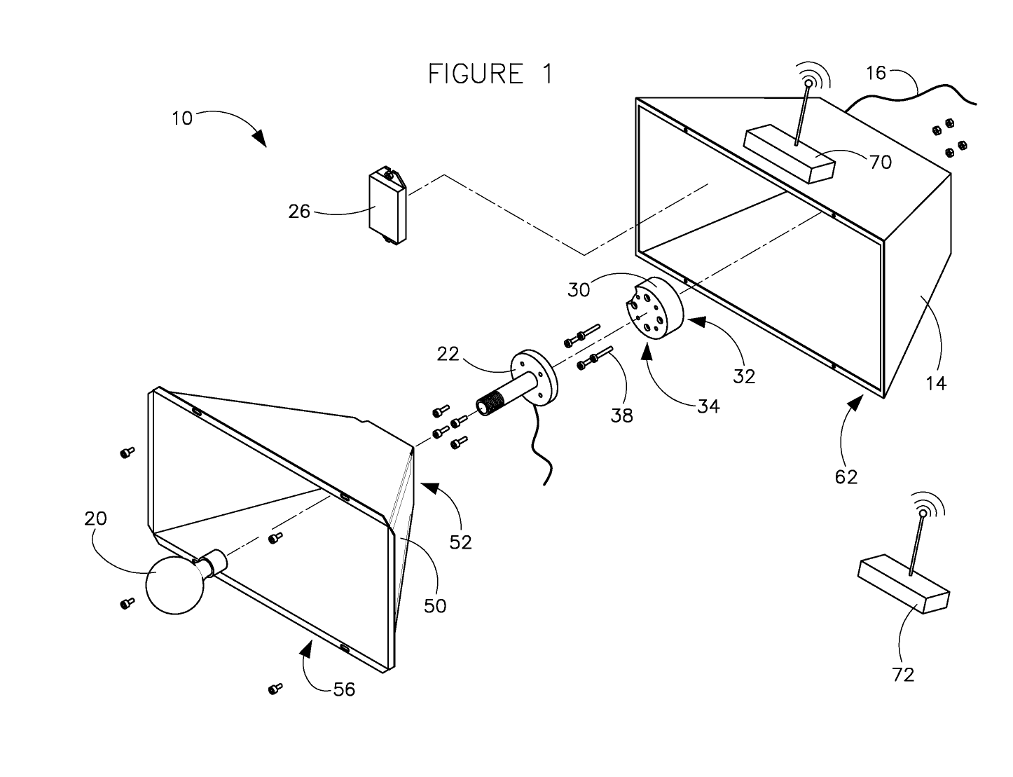

Referring more particularly to FIG. 1 an exploded view of a retrofit kit 10 for an existing lighting fixture is shown according to an exemplary embodiment. Retrofit kit 10 includes an illumination source (shown as lamp 20), a coupler 22 (e.g. base, lamp holder, etc.), a high-frequency generator 26, a heat sink 30, and a reflector 50 (shown by way of example as a rectangular or pyramid type reflector). According to one embodiment, the lamp and coupler and high-frequency generator may comprise an induction lighting system, such as (but not limited to) a system of a type known as a QL Induction Lighting System commercially available from Philips Lighting Company of Somerset, N.J. The components of the retrofit kit 10 are configured to be packaged (i.e. assembled and installed within, etc.) the body or housing 14 of an existing lighting fixture, after removal of the components of the conventional (i.e. energy-intensive) lighting system have been removed. According to the illustrated embodiment, the existing housing has a generally rectangular shape, and the components of the retrofit kit are shown for adaptation to such a rectangular housing (such as are typically used for shipping/loading dock lights and the like). However, the retrofit kit is also adaptable for use with other existing lighting fixtures having housings with other geometric shapes. The provision of the components as a retrofit kit are intended to preserve to existing lighting infrastructure, to the extent practical and cost-effective, in order to gain the advantages of a more energy-efficient lighting technology, without having to sacrifice the investment in the original fixture infrastructure (e.g. mounting systems, housings, supply wiring, sensors, etc.).

Referring further to FIG. 1, the existing (energy-intensive) lighting fixture is converted to a more energy-efficient lighting fixture by removing the illumination components (e.g. bulbs, ballasts, reflectors, etc.) associated with the old lighting technology, and replacing them with the components of the retrofit kit 10 in (by way of example) the following manner. The high-frequency generator 26 is coupled (e.g. by screws, clips, brackets, etc.) to an inside back surface of the existing housing 14 in a heat transfer relationship (i.e. directly coupled in contact, or coupled in contact with a thermally conductive intermediary element, etc.), so that at least a portion of the heat generated by the high-frequency generator 26 may be transferred to, and dissipated by, the existing housing 14. The high-frequency generator 26 is then electrically coupled to the existing electrical supply 16 (e.g. by quick-connectors or other suitable electrical connection).

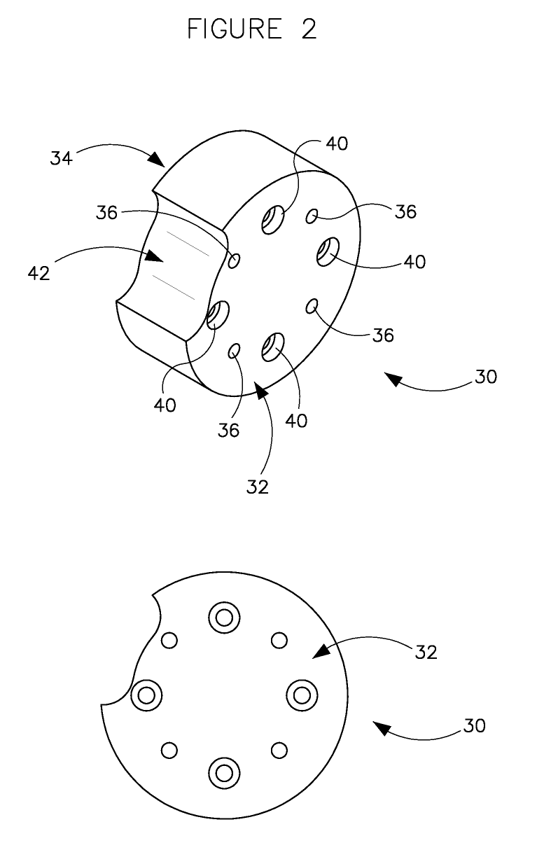

The heat sink 30 (shown in further detail in FIG. 2) is shown by way of example as formed in the shape of substantially circular member and is made from a thermally conductive metallic material (e.g. 5000 or 6000 series aluminum, or other suitable material and formed in a machining operation or the like), and is also coupled to the inside back surface of the existing housing 14 in a heat transfer relationship (i.e. directly coupled in contact, or coupled in contact with a thermally conductive intermediary element, etc.), so that at least a portion of the heat generated by the bulb 20 and coupler 22 may be transferred through the heat sink 30 and then dissipated by the existing housing 14. As shown in FIG. 2, heat sink 30 has a first side 32 oriented toward the housing and a second side 34 oriented toward the coupler 22. The first side 32 is formed with suitable first connection receptacles 36 (e.g. threaded bores, etc.) intended to receive coupling structure (e.g. threaded fasteners such as bolts 38) to mount the heat sink 30 to the existing housing 14. The second side 34 of the heat sink 30 is formed with second connection receptacles 40 intended to receive and secure coupler 22 (and support bulb 20) using suitable fasteners (not shown). Upon mounting the coupler 22 to the heat sink 30, the bulb 20 is then mounted onto the coupler 22.

Referring further to FIG. 2, heat sink 30 includes a cutout region 42 (e.g. recesses, etc.) shown by way of example along a portion of its peripheral edge, as may be necessary in certain installations for avoiding existing structures on the inside back surface of the housing, which would otherwise interfere with placement of the first side 32 of the heat sink 30 in direct contact with the housing 14. Although the cutout region 42 is shown by way of example as portion that extends through the entire depth or thickness of the heat sink 30, other cutout regions or recesses may be provided that extend only partially through the thickness of the heat sink, or that are provided at a non-peripheral location on the heat sink, as may be necessary to adapt the shape and contour of the heat sink to avoid existing interferences on the housing, while enhancing the amount of direct contact between the heat sink and the housing. All such variations are intended to be within the scope of this disclosure.

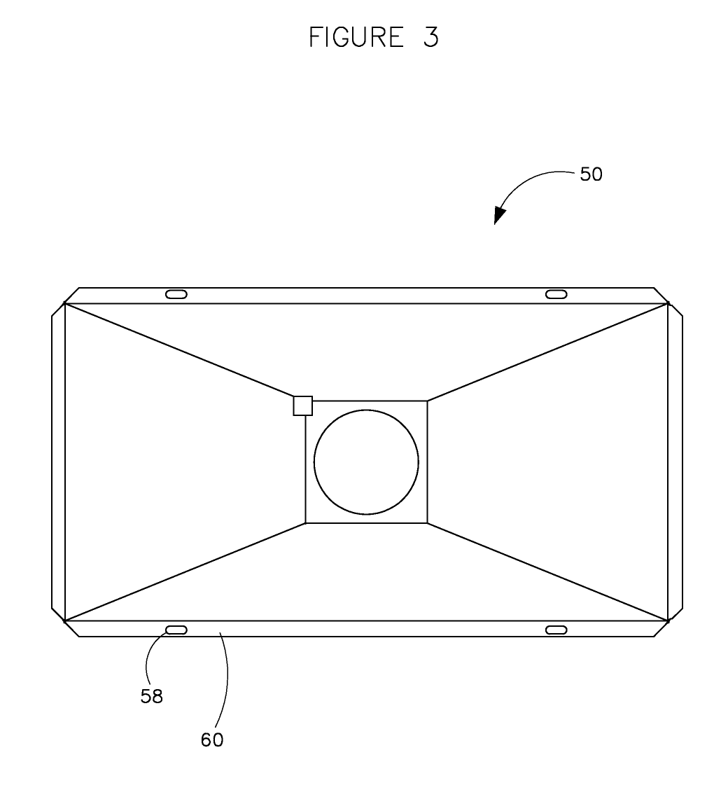

The reflector 50 (shown in further detail in FIG. 3) formed from a sheet of reflective material (e.g. Aland Miro silver finish, in a thickness of approximately 0.015 or 0.020 inches, etc.) in a stamping and bending operation to form a reflector in the shape of a truncated rectangular pyramid (although reflectors having other geometric shapes may be used to suit the size, shape and application of any of a wide variety of existing light fixture housings). The reflector 50 has a narrow end 52 shown to have a generally circular base opening 54 configured to fit around the heat sink 30, and a wide end 56 having connection receptacles (e.g. slotted openings 58 on a peripheral rim 60, etc.) configured to be coupled (e.g. by clips, threaded fasteners, etc.) proximate an outer edge 62 of the existing housing 14. According to alternative embodiments, the outer edge 60 of the reflector 50 may be configured to snap-fit onto the outer edge 62 of the housing 14 (e.g. directly, or through suitable clips, etc.).

Although the assembly and installation of the components of the retrofit kit for converting an energy-intensive fixture into a more energy-efficient fixture have been prescribed in a particular order according to one exemplary embodiment, other assembly sequences, or coupling devices/methods for securing the components within the existing housing, and transferring heat from the bulb to the housing, may be used.

According to alternative embodiments, the retrofit kit may also include other components, such as a clear cover or lens, and/or protective wire guards, etc., that are configured to fit over the outer edge of the housing or reflector. The kit may also include other components intended to enhance the energy-efficiency of the fixture, such as sensors (e.g. motion, sound, infrared, ambient light level, etc.) that may be configured to turn the bulb on and/or off in response to certain environmental conditions (e.g. presence or absence of motion, light, sound, etc.).

According to other alternative embodiments, the retrofit kit may also include other components intended to further enhance the energy-efficiency of the fixture, such as transceivers that may be coupled to the existing housing and configured to communicate (e.g. on a suitable RF frequency) with a master controller (or other control device) that may be remotely or locally programmed to provide operational instructions for the fixture, and which otherwise override the operating instructions provided by such sensors as may be provided. The transceivers and controllers of the present application may generally be configured to include features disclosed in U.S. patent application Ser. No. 12/550,270 titled “Lighting Fixture Control Systems and Methods” and filed on Aug. 29, 2009, the complete disclosure of which is hereby incorporated by reference herein.

According to any preferred embodiment, a retrofit kit is provided for converting existing dock-lighting type fixtures and/or similar fixtures (e.g. bridges, tunnels, signage, portable construction lighting, etc.) having an energy-intensive lighting source, into an upgraded fixture having a more energy-efficient light source, and includes a reflector, induction lighting source, and a heat sink and coupler, that are configured to be ‘packaged’ (or otherwise installed) within the housing or enclosure of the existing fixture, using suitable hardware.

As utilized herein, the terms “approximately,” “about,” “substantially,” and similar terms are intended to have a broad meaning in harmony with the common and accepted usage by those of ordinary skill in the art to which the subject matter of this disclosure pertains. It should be understood by those of skill in the art who review this disclosure that these terms are intended to allow a description of certain features described and claimed without restricting the scope of these features to the precise numerical ranges provided. Accordingly, these terms should be interpreted as indicating that insubstantial or inconsequential modifications or alterations of the subject matter described and claimed are considered to be within the scope of the invention as recited in the appended claims.

It should be noted that the term “exemplary” as used herein to describe various embodiments is intended to indicate that such embodiments are possible examples, representations, and/or illustrations of possible embodiments (and such term is not intended to connote that such embodiments are necessarily extraordinary or superlative examples).

The terms “coupled,” “connected,” and the like as used herein mean the joining of two members directly or indirectly to one another. Such joining may be stationary (e.g., permanent) or moveable (e.g., removable or releasable). Such joining may be achieved with the two members or the two members and any additional intermediate members being integrally formed as a single unitary body with one another or with the two members or the two members and any additional intermediate members being attached to one another.

It should be noted that the orientation of various elements may differ according to other exemplary embodiments, and that such variations are intended to be encompassed by the present disclosure.

It is also important to note that the construction and arrangement of the retrofit kit for converting existing light fixtures having an energy-intensive lighting source, into an upgraded fixture having a more energy efficient light source, as shown in the various exemplary embodiments is illustrative only. Although only a few embodiments of the present inventions have been described in detail in this disclosure, those skilled in the art who review this disclosure will readily appreciate that many modifications are possible (e.g., variations in sizes, dimensions, structures, shapes and proportions of the reflector and other various elements, values of parameters, wattage of the light source, mounting arrangements, use of materials, colors, orientations, etc.) without materially departing from the novel teachings and advantages of the subject matter disclosed herein. For example, elements shown as integrally formed may be constructed of multiple parts or elements, the position of elements may be reversed or otherwise varied, and the nature or number of discrete elements or positions may be altered or varied. Accordingly, all such modifications are intended to be included within the scope of the present invention as defined in the appended claims. The order or sequence of any process or method steps may be varied or re-sequenced according to alternative embodiments. Other substitutions, modifications, changes and omissions may be made in the design, operating conditions and arrangement of the various exemplary embodiments without departing from the scope of the present inventions.

What is claimed is:

1. A retrofit kit for converting an existing light fixture having a housing and an energy-intensive light source, into an upgraded fixture having a more energy-efficient light source, the retrofit kit comprising:
a reflector configured to be coupled to the housing;
an induction light bulb;
a high-frequency generator configured to be coupled to the housing in a heat-transfer relationship;
a coupler coupled to the induction light bulb and electrically coupled to the high-frequency generator; and
a heat sink configured to support the coupler and the induction light bulb, and to receive heat from the coupler and the induction light bulb, the heat sink configured to be coupled to the housing in a heat-transfer relationship to transfer the heat to the housing of the existing light fixture.

2. The kit of claim 1, wherein the heat sink comprises a metallic member having a cutout region disposed therein and configured to provide a clearance between the heat sink and existing structural interferences on the housing.

3. The kit of claim 2 wherein the heat sink comprises a first side engagable with the housing and having a first set of connection receptacles configured for attachment of the first side to the housing.

4. The kit of claim 3 wherein the heat sink comprises a second side engagable with the coupler and having a second set of connection receptacles configured for supporting the coupler on the heat sink.

5. The kit of claim 1, wherein the reflector comprises a flat sheet of reflective material that is formed into a truncated rectangular pyramid shape having a narrow end with a substantially circular opening configured to fit about the heat sink, and a wide end having a peripheral lip configured to engage the housing.

6. The kit of claim 1, further comprising a transceiver configured to be coupled to the housing, the transceiver operable to control illumination of the induction light bulb in response to wireless signals transmitted by a remotely disposed control device.

7. A retrofit kit for converting an existing light fixture having a housing and an energy-intensive light source, into an upgraded fixture having a more energy-efficient light source, the retrofit kit comprising:
an induction light bulb mountable on a coupler;
a high-frequency generator electrically connectable to the coupler and configured to be mounted on the housing in a heat-transfer relationship;
a heat sink configured to support the coupler and the induction light bulb, and to receive heat from the coupler and the induction light bulb, the heat sink configured to be mounted to the housing in a heat-transfer relationship to transfer the heat to the housing of the existing light fixture; and
a reflector configured to be coupled to the housing, the reflector having a narrow end configured for positioning proximate the heat sink, and a wide end configured for positioning proximate an outer edge of the housing.

8. The kit of claim 7 wherein the heat sink comprises a metallic member having cutout region configured to avoid interfering structure on the housing.

9. The kit of claim 8 wherein the heat sink comprises a first side engagable with the housing and having a first set of connection receptacles configured for attachment of the first side to the housing.

10. The kit of claim 9 wherein the heat sink comprises a second side engagable with the coupler and having a second set of connection receptacles configured for supporting the coupler on the heat sink.

11. The kit of claim 7, wherein the reflector comprises a flat sheet of reflective material that is formed into a truncated rectangular pyramid shape with the narrow end having a substantially circular opening configured to fit about the heat sink, and the wide end having a peripheral lip configured to engage the housing.

12. A method of converting an existing light fixture having a housing and an energy-intensive light source, into an upgraded fixture having a more energy-efficient light source, the method comprising:
obtaining an induction light bulb, a coupler, and a high-frequency generator;
electrically connecting the high-frequency generator to the coupler;
coupling the high-frequency generator to the housing in a heat-transfer relationship;
coupling a heat sink to the housing in a heat-transfer relationship
supporting the induction light bulb and the coupler on the heat sink, the heat sink configured to receive heat from the coupler and the induction light bulb and transfer the heat to the housing; and
coupling a reflector to the housing, the reflector having a narrow end configured for positioning proximate the heat sink, and a wide end configured for positioning proximate an outer edge of the housing.

13. The method of claim 12 further comprising the step of electrically connecting the high-frequency generator to an existing source of electricity.

14. The method of claim 11 further comprising the step of coupling a transceiver to the housing, the transceiver operable to control illumination of the induction light bulb in response to wireless signals transmitted by a remotely disposed control device.

15. The method of claim 12 wherein the heat sink comprises a first side engagable with the housing and having a first set of connection receptacles configured for attachment of the first side to the housing, and a second side engagable with the coupler and having a second set of connection receptacles configured for supporting the coupler on the heat sink.
